(19) United States
(12) Patent Application Publication
(10) Pub. No.: US 2026/0171506 A1
(43) Pub. Date: Jun. 18, 2026

(54) SOLID-STATE BATTERY ELECTRODE EDGE TRIMMING

(71) Applicant: Ford Global Technologies, LLC, Dearborn, MI (US)

(72) Inventors: Minghong Liu, Canton, MI (US); Wenhui Zhu, Northville, MI (US); Kent Snyder, Dearborn, MI (US)

(21) Appl. No.: 18/986,235

(22) Filed: Dec. 18, 2024

(51) Int. Cl. H01M 10/0587; H01M 50/105

(52) U.S. Cl. CPC H01M 10/0587; H01M 50/105; H01M 2220/20

(57) ABSTRACT

Methods are provided for cutting electrodes in a solid-state battery. In one example approach, a method comprises arranging electrodes in a stack, the stack comprising a first and oppositely charged second electrode, wherein the first electrode overhangs the second electrode; laminating the first and second electrodes in the stack; cutting a portion of the overhang around the perimeter of the first electrode with a laser; and removing the cut portion of the overhang from the first electrode so that the first electrode overhangs the second electrode by an amount that is less than or approximately equal to a threshold amount.

### TECHNICAL FIELD

The present disclosure relates to solid-state batteries.

### BACKGROUND AND SUMMARY

A solid-state battery (SSB) is a type of battery that uses a solid electrolyte for ionic conductions between the electrodes, instead of liquid or gel polymer electrolytes found in conventional batteries, for example. In some examples, solid-state batteries may use metallic lithium for the anode and oxides or sulfides for the cathode, thereby increasing energy density. The solid electrolyte may act as a separator that allows only lithium ions to pass through. Solid-state batteries may potentially provide higher energy density or preferred abuse tolerance characteristics compared to typical lithium-ion or lithium polymer batteries, for example. Solid-state batteries may be used in a variety of devices and machines including, but not limited to common consumer electronics applications, pacemakers, Radio Frequency Identification (RFID) and wearable devices, and electric or hybrid electric vehicles, for example.

In some approaches, fabrication of some SSB cell configurations may involve a process to laminate layers to form an electrode stack under high pressure. The laminated electrode stack may be vacuum sealed inside a pouch bag or the like. In some examples, the completed SSB cells may undergo charging and discharging with controlled compression force and temperature. Misalignment of electrodes may cause various issues. An effective approach for manufacturing-induced misalignment of electrodes may be a lateral extension of the negative electrode, referred to as anode overhang. Such electrode overhangs may provide for a desired margin for potential stack misalignment.

A post-lamination trimming of electrode stack (also called Jelly Roll) edges using a high precision laser cutting method is provided herein. In one example approach, a method for cutting electrodes in a battery is provided that comprises: arranging electrodes in a stack, the stack comprising a first electrode and a second electrode, where the first electrode has a charge opposite a charge of the second electrode and wherein the first electrode has an overhang region that overhangs the second electrode around a perimeter of the second electrode; laminating the first and second electrodes in the stack so that the electrodes are affixed together in the stack; cutting a portion of the overhang region around the perimeter of the first electrode with a laser; and removing the cut portion of the overhang region from the first electrode so that the first electrode overhangs the second electrode by an amount that is less than or approximately equal to a threshold amount.

Such a laser cutting method may provide for a sufficient stack edge trimming to reduce or potentially prevent occurrences of the anode layer from reaching the cathode layer even if the anode layer is at a significant overlap bend angle, for example, while still retaining a useful margin for potential stack misalignment. The methods described herein may reduce the internal shorting in non-tab areas of the cell occurring via exposure to the related edge stresses experienced in the electrode stack packaging and/or charging/discharging by reducing the final anode overlap distance prior to electrode stack packaging into the cell.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example electric vehicle with a battery.

FIG. 2 shows a perspective view of an example battery.

FIG. 3 shows a cross-sectional view of an example bipolar battery with an electrode stack.

FIG. 4 shows a cross-sectional view of an example monopolar battery with an electrode stack.

FIG. 5 shows a detail view of edges of electrodes in an example bipolar battery.

FIG. 6 shows a detail view of edges of electrodes in an example monopolar battery.

FIG. 7 shows a top view of an example battery with an electrode stack.

FIG. 8 shows an example method for cutting electrodes in a battery.

### DETAILED DESCRIPTION

The following description relates to methods for post-lamination trimming of electrode stack edges using high precision laser cutting methods. In some examples, pressure changes during charging and discharging of laminated electrode stacks may result in performance degradation of such batteries. For example, overhanging areas of anode (i.e., negative electrode) layers may break along lines that overlap with the edges of the cathodes (i.e., positive electrodes). Such breaks may be caused by fragility of the anodes and/or electrode stress experienced during charging and discharging under pressure, for example. When such breaks occur, the anode, including the anode coating and/or the current collector, may touch the cathode edge leading to internal shorting, for example. Therefore, post-lamination methods for trimming electrode stack edges using high precision laser cutting methods are provided herein. In particular, methods are provided herein for trimming regions of an electrode that overlap or extend beyond an adjacent oppositely charged electrode. For example, a size or dimensions (e.g., length and/or width) of an anode may be larger than a size or dimensions (e.g., length and/or width) of a cathode so that, when formed in a stack, an overlap margin is provided to accommodate potential stack misalignment during the process of forming the stack. Trimming the electrode overlaps to reduce the overlap amount may reduce occurrences of adjacent electrodes coming into electrical contact with each other. Various laser cutting methods may be used to trim electrode overlaps to provide for a sufficient stack edge trimming to reduce or potentially prevent occurrences of the anode layer from reaching the cathode layer even if the anode layer is at a significant overlap bend angle, for example, while still retaining a useful margin for potential stack misalignment. The methods described herein may reduce internal shorting in non-tab areas of the battery cell occurring via exposure to the related edge stresses experienced in the electrode stack packaging and/or charging/discharging by reducing the final anode overlap distance prior to electrode stack packaging into the cell.

It is to be understood that the specific assemblies and systems illustrated in the attached drawings, and described in the specification are example embodiments of the inventive concepts defined herein. For purposes of discussion, the drawings may be described collectively. Thus, like elements may be commonly referred to herein with like reference numerals and may not be re-introduced.

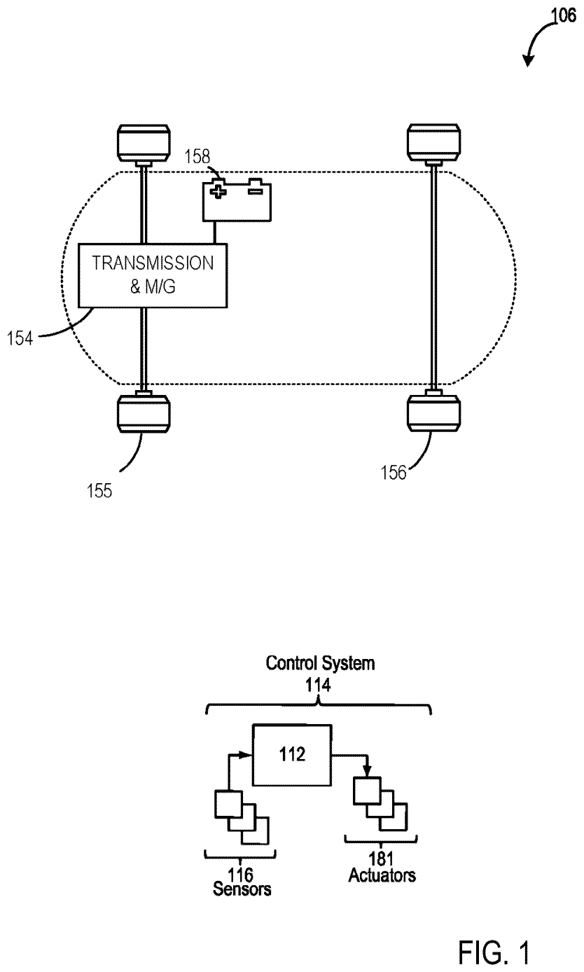

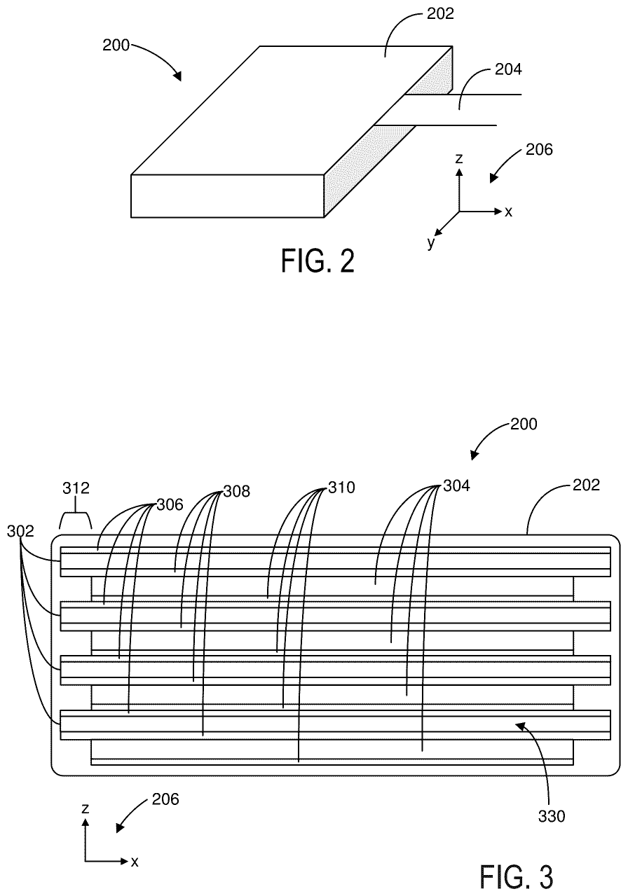

Turning now to the figures, FIG. 1 shows a schematic depiction of an example vehicle system 106 that can derive propulsion power from an electric motor 154 (e.g., a drive motor). As used herein, the terms “electric vehicle” or “EV” is intended to mean any suitable vehicle that is at least partially configured to be propelled using electric power, e.g., via one or more electric motors incorporated in the vehicle. For example, vehicle system 106 may be considered to be an electric vehicle (EV). Though FIG. 1 shows a single electric motor 154, it should be understood that vehicle system 106 may include any suitable number of electric motors to propel the vehicle and/or provide power to various components and systems within system 106. In some examples, electric motor 154 may be a traction motor, however other types of electric motors are contemplated. Electric motor 154 may receive electrical power from a battery 158 to provide torque to rear vehicle wheels 155. Electric motor 154 may also be operated as a generator to provide electrical power to charge battery 158, for example, during a wheel caliper application operation. In some examples, battery 158 may comprise a solid-state battery (SSB) such as described below with reference to FIGS. 2-5.

It should be appreciated that while FIG. 1 depicts an electric motor 154 mounted in a rear wheel drive configuration, other configurations are possible, such as employing electric motor 154 in a front wheel configuration, or in a configuration in which there is an electric motor mounted to both the rear vehicle wheels 155 and front vehicle wheels 156. Further, additional electric motors may be included in system 106.

Electric motor 154 may include a gearbox integrated therein and/or may provide input power, together with other electric motors, to a transmission system. Additionally, or alternatively, the electric motor 154 may be coupled to an outside of a transmission/gearbox housing. The integrated gearbox may include one or more input speed reduction gear sets. Electric motor 154 may also include at least one clutch. Controller 112 may send a signal to an actuator of the clutch(es) to engage or disengage the clutch(es), so as to couple or decouple power transmission from the electric motor 154 to the rear vehicle wheels 155 or the front vehicle wheels 156. Additionally, or alternatively, there may be multiple batteries configured to provide power to different driven wheels, wherein power to the wheels may be predicated based on traction at the wheels, driver demand, and other conditions.

Controller 112 may form a portion of a control system 114. Control system 114 is shown receiving information from a plurality of sensors 116 and sending control signals to a plurality of actuators 181. As one example, sensors 116 may include sensors such as a battery level sensor, clutch activation sensor, etc. As another example, the actuators may include the clutch, etc. The controller 112 may receive input data from the various sensors, process the input data, and trigger the actuators in response to the processed input data based on instructions or code programmed therein corresponding to one or more routines.

Turning now to FIGS. 2-7, various views of an example battery 200 are shown. An axis system 206 is provided in the FIGS. 2-7 for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

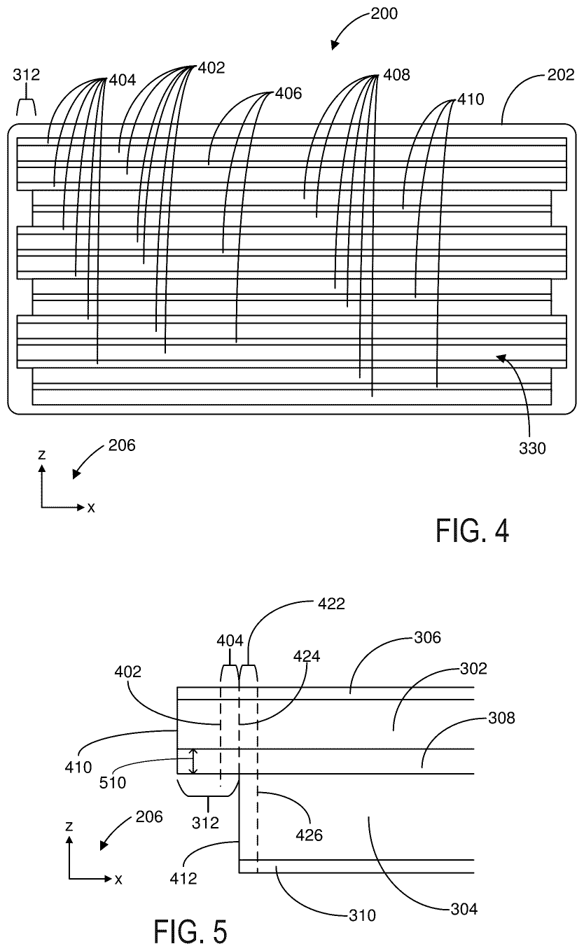

FIG. 2 shows a perspective view of an example battery 200. Battery 200 may comprise a solid-state battery and may include an electrode stack (e.g., electrode stack 330 shown in FIGS. 3 & 4) within a pouch 202. The solid-state battery may have any suitable design, e.g., bipolar (as shown in FIGS. 3 &5) or monopolar (as shown in FIGS. 4 & 6). The pouch may comprise a bag or other suitable container that is vacuum sealed around the electrode stack, for example. One or more tabs 204 may be included in battery 200 that are in electrical communication with electrode current collectors in the battery.

FIG. 3 shows a cross-sectional view of example battery 200 with an electrode stack 330 enclosed in pouch 202. The example solid-state battery shown in FIG. 3 has a bipolar cell structure (an example battery with monopolar cell structure is shown in FIG. 4, where like elements use like numbering). Pouch 202 may form a container, a pocket or a cavity which houses the electrode assembly including the electrode stack 330. In some embodiments, the pouch 202 may comprise a porous plastic tube, pouch, or sleeve made of any suitable material, for example. Stack 330 comprises a plurality of electrodes and other components of a solid-state battery, such as electrode coatings, current collectors, solid-state electrolytes separators, etc. For example, as shown in FIG. 3, electrode stack 330 comprises a plurality of anodes 302 (i.e., negatively charged electrodes) and a plurality of cathodes 304 (i.e., positively charged electrodes) arranged in a stack formation. Each anode may have an anode current collector 306 (i.e., an anode electrical contact) that is in contact with a surface of the anode. Each cathode may have a cathode current collector 310 (i.e., a cathode electrical contact) that is in contact with a surface of the cathode. The anodes and cathodes included in stack 330 may have various coatings disposed thereon in some examples. Solid-state electrolytes 308 (i.e., solid-state electrolyte separators) may be disposed between the anodes and cathodes.

As remarked above, battery 200 may comprise a solid-state battery. A solid-state battery is an electrical battery that uses a solid electrolyte for ionic conductions between the electrodes, instead of liquid or gel polymer electrolytes found in conventional batteries. Solid-state batteries may provide higher energy density than the typical lithium-ion or lithium polymer batteries. The cathodes 304 (i.e., positive electrodes), may be made with the same compounds as a lithium-ion battery (e.g., LFP, NMC, LMO, etc). The anodes 302 (i.e., negative electrodes) may be made of lithium metal (e.g., pure lithium), in some examples. In some examples, a negative electrode may be formed by coating a negative electrode active material such as a lithium metal, a lithium alloy, carbon, petroleum coke, activate carbon, graphite, silicon, silicon oxide, silicon composite, titanium-based material, or the like, on surfaces of a negative electrode current collector made of copper, nickel, a copper alloy, other potential conductive materials, or any combination thereof. Also, a positive electrode may be formed by coating a positive electrode active material such as a lithium manganese oxide, a lithium cobalt oxide, a lithium nickel oxide, or the like, on surfaces of a positive electrode current collector made of aluminum, nickel, other potential conductive materials, or a combination thereof.

As illustrated in FIG. 3, the negative electrodes 302 and the positive electrodes 304 may be stacked with separators 308. The separators 308 may be comprised of a generally ceramic (e.g., oxides, sulfides, phosphates), or a solid polymer, which also functions as the electrolyte. It therefore becomes the medium through which the ions move and also has electric insulating properties and functions as a mechanical separator between the anodes and cathodes. The solid electrolyte may function as an ideal separator that allows only lithium ions to pass through. For that reason, solid-state batteries can potentially address various issues of liquid electrolyte Li-ion batteries. The separators may be made of a material generally used in the art. For example, a multi-layer film made of polyethylene, polypropylene, or a combination thereof having a microporous structure, or a polymer film for a gel-type polymer electrolyte or a solid polymer electrolyte such as polyvinylidene fluoride, polyethylene oxide, polyacrylonitrile, or polyvinylidene fluoride hexafluoropropylene copolymer may be used.

FIG. 4 shows a cross-sectional view of an example solid-state battery 200 with a monopolar cell structure. Like-numbered elements shown in FIG. 4 correspond to like-numbered elements shown in FIG. 3 described above. The example monopolar electrode stack 330 shown in FIG. 4 comprises an anode layer that comprises solid electrolyte separators 404 that form boundaries to anode coatings 402 on top and bottom surfaces of anode current collectors 406. The cathode layers in this example comprise cathode coatings 408 on top and bottom surfaces of cathode current collectors 410.

The electrodes and other components in the electrode stacks 330 shown in FIGS. 3 & 4 may be laminated together to affix all the components together. Lamination is a technique/process of manufacturing a material in multiple layers. A laminate is a layered object or material that may be assembled using heat, pressure, welding, or adhesives. Various coating machines, machine presses and/or calendering equipment may be used to laminate the layers in the electrode stack 330. The electrodes and other layers in the electrode stack 330 may be laminated together prior to any laser cutting.

Misalignment of electrodes may cause battery performance degradation, e.g., may cause lithium plating at the negative electrode edges. Therefore, an effective countermeasure for manufacturing-induced misalignment of electrodes may be a lateral extension of the negative electrode, referred to as anode overhang. Such electrode overhangs may provide for a useful margin for potential stack misalignment.

For example, an electrode overhang 312 is shown in FIGS. 3 & 4, where edges of the anode layers extend beyond edges of the cathodes layers. In some examples, anode coatings, current collectors and or solid-state electrolyte layers may also extend beyond the cathode by an overhang distance. For example, a size of the anodes and/or anode layers may be greater than a size of the cathodes and/or cathode layers to form an overhang. If the anode layers and cathode layers are substantially rectangular in shape, then the length and width of the anode layers may be greater than the length and width of the cathode layers to form the overhangs. In some examples, the initial overhang distance (before any laser cutting is performed, as described below) may be greater than 1.0 mm; however, in other examples, the overhang distance may be less than 1.0 mm.

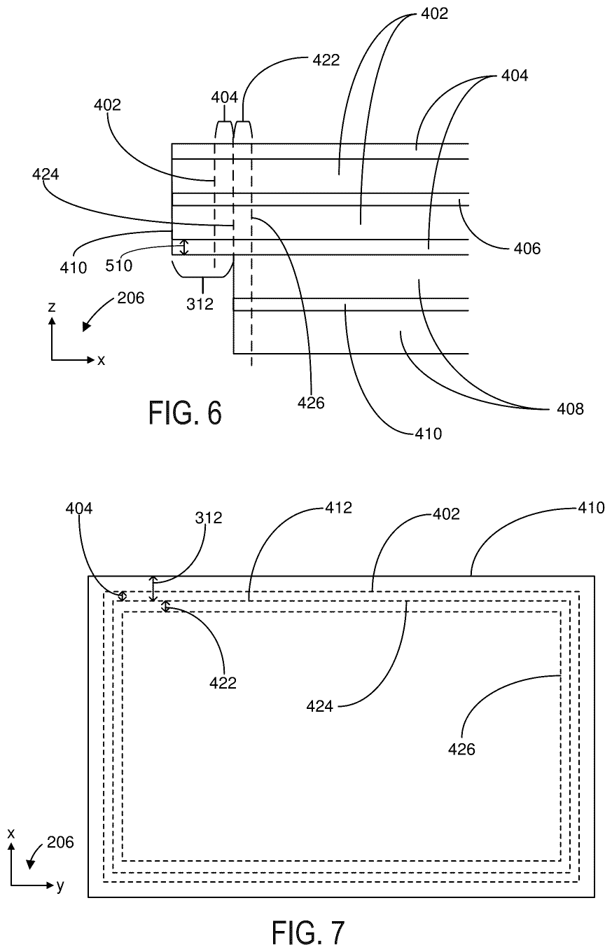

Turning now to FIGS. 5-7, FIG. 5 shows a detail view of the edges of some of the electrodes in an example bipolar battery, such as battery 200 shown in FIG. 3 described above. FIG. 6 shows a detail view of edges of electrodes in an example monopolar battery, such as battery 200 shown in FIG. 4. FIG. 7 shows a top view of the example battery 200 (monopolar or bipolar, for example) with an electrode stack. In FIGS. 5-7 the electrode overhang 312 is shown. As shown in FIGS. 5-7, the overhang 312 may be a distance that edges 410 of the anode layers extend past the edges 412 of the cathode layers. In some examples, this overhang 312 may be greater than 1.0 mm before performing any laser cutting steps described herein. However, in other examples, the overhang 312 may be less than 1.0 mm before any laser cutting is performed.

As remarked above, overhanging areas of anode layers (i.e., negative electrodes) may break along lines that overlap with the edges of the cathode layers (i.e., positive electrodes). Such breaks may be caused by fragility of the anodes and/or electrode stress experienced during charging and discharging under pressure, for example. As another example, the anode or anode layers may break along a line that overlaps with the cathode during the pouch sealing process when a vacuum is applied. When such breaks occur, the anode, including the anode coating and/or the current collector, may touch the cathode edge leading to internal shorting, for example.

In order to address these and other issues, post-lamination methods for trimming electrode stack edges using high precision laser cutting methods may be performed. For example, as shown in FIGS. 5 and 6, the overhanging electrode (in this case anode 302 or the anode layer) and any other overhanging component associated with the anode, such as anode current collector 306 and any included anode coatings, may be cut using a suitable laser cutting method in order to shorten the overhang length.

In one example, a laser cutting method may be used to cut the overhanging electrode at a trim line 402 so that when the cut overhang region is removed, a distance 404 of the overhang is less than thickness 510 of the separator (e.g., separator 308 or 404). In some approaches, after trimming, the overhanging width 404 may be less than half (50%) of the thickness 510 of solid electrolyte separator (308 or 404) or polyolefin separator, so that even if the overhanging area is bent during vacuum seal or cycling, it won't touch the cathode or cathode layer to cause a short circuit. In another example, substantially all of the overhanging area may be removed by cutting along trim line 424. In this example, if the electrode stack had good alignment at the beginning, there may not be any overhang area. In still another example, trimming may occur along trim line 426 so that the electrodes are trimmed along trim line 426 that extends a distance 422 into the edge of the cathode or cathode layer. For example, distance 422 may be in a range of 0.5-1.0 mm depending on a tolerance of the electrode stacking process. The purpose of this approach is to ensure that the anode, cathode and separator have substantially the same width and length and all layers are aligned.

Any suitable laser cutting method may be used to trim the overhanging electrodes. For example, UV, fiber, CO₂, Nd:YAG or Nd:YVO laser methods may be used (or a combination of any). In some examples, the laser cutting methods may be able to cut with a dimensional accuracy of ≤50% of the thickness of a typical solid SSB solid-state electrolyte (SSE) separator layer, thereby allowing for sufficient stack edge trimming to reduce occurrences of the anode layer from reaching the cathode layer even if the anode layer is at a significant overlap bend angle, for example, while still retaining a useful margin for potential stack misalignment. This trimming may reduce internal shorting in non-tab areas of the battery cell occurring via exposure to the related edge stresses experienced in the electrode stack packaging and/or charging/discharging by reducing the final anode overlap distances prior to electrode stack packaging into the cell.

FIGS. 1-7 are drawn approximately to scale, aside from the schematically depicted components. However, the components may have other relative dimensions, in other embodiments. The figures show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Even further, elements which are coaxial or parallel to one another may be referred to as such.

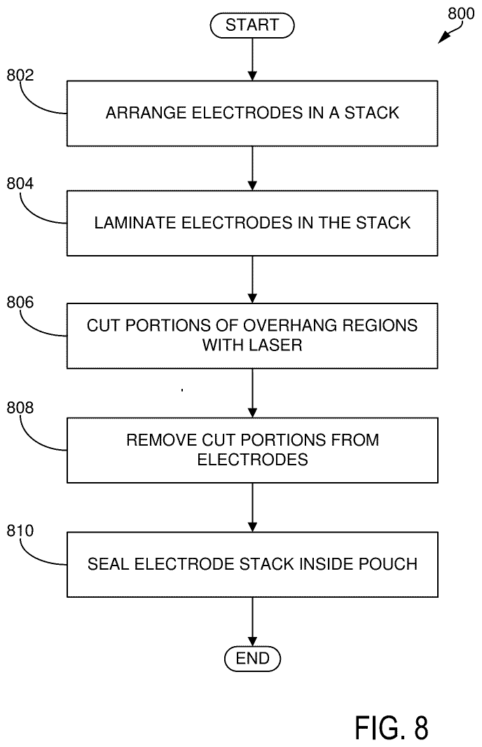

FIG. 8 shows an example method 800 for cutting electrodes in a battery. For example, method 800 may be used to trim electrode overhangs in a solid-state battery, such as battery 200. At 802, method 800 includes arranging electrodes in a stack. Arranging electrodes in a stack may comprise positioning a plurality of electrodes, current collectors, solid-state electrolyte layers and the like into a substantially aligned stack, as shown in FIG. 3 for example. For example, the stack may comprise a first electrode and a second electrode, where the first electrode has a charge opposite a charge of the second electrode and wherein the first electrode has an overhang region, e.g., overhang 312, that overhangs the second electrode around a perimeter of the second electrode. In some examples, the electrode may comprise a plurality of electrodes (e.g., more than two anode and cathode layers), thus the electrode may additionally comprise a third electrode and a fourth electrode (in addition to the first and second electrodes), where the third electrode has a charge opposite a charge of the fourth electrode and wherein the third electrode has a second overhang region that overhangs the fourth electrode around a perimeter of the fourth electrode. The stack may additionally comprise a solid-state electrolyte (e.g., SSE 308) between the first electrode and the second electrode and also between the third electrode and the fourth electrode.

At 804, method 800 includes laminating electrodes in the stack. For example, a suitable lamination process may be performed to affix the electrode and other components, such as SSE's, current collectors and the like, together in the stack. At 806, method 800 includes cutting portions of electrode overhang regions with a laser. For example, a portion of the overhang regions around the perimeter of the overhanging electrodes in the stack may be cut with a laser. The laser may cut with a dimensional accuracy of less than 50% of a thickness of the solid-state electrolyte. In some examples, the laser may be one of a UV laser, a CO₂ laser, a Nd:YAG laser, a Nd:YVO laser, or a combination thereof.

At 808, method 800 includes removing the cut portions from electrodes. For example, after cutting the overhang regions with a laser, the cut portions of the overhang regions may be removed so that the electrode overhang distance (e.g., distance 404) may be less than or approximately equal to a threshold amount. In some examples, the threshold amount may be approximately half of the thickness of the separator (e.g., separator 308 or 404 described above), so that all the electrode overhangs in the stack are less than or equal to approximately half of the thickness of the separator. At 810, method 800 includes sealing the electrode stack inside a pouch. For example, a flexible container, pocket or pouch may be vacuum sealed around the electrode stack to form the battery unit.

The invention will be further described in the following paragraphs. In one aspect, an method for cutting electrodes in a battery is provided that comprises: arranging electrodes in a stack, the stack comprising a first electrode and a second electrode, where the first electrode has a charge opposite a charge of the second electrode and wherein the first electrode has an overhang region that overhangs the second electrode around a perimeter of the second electrode; laminating the first and second electrodes in the stack so that the electrodes are affixed together in the stack; cutting a portion of the overhang region around the perimeter of the first electrode with a laser; and removing the cut portion of the overhang region from the first electrode so that the first electrode overhangs the second electrode by an amount that is less than or approximately equal to a threshold amount.

In some aspects, the method may further comprise sealing the stack inside a pouch. In some examples, the battery may be a solid-state battery. In some examples, the threshold amount may be half of the thickness of the separator. In some aspects, the first electrode may be an anode and the second electrode may be a cathode. In additional aspects, the stack may additionally comprise a third electrode and a fourth electrode, where the third electrode has a charge opposite a charge of the fourth electrode and wherein the third electrode has a second overhang region that overhangs the fourth electrode around a perimeter of the fourth electrode; and wherein the method further comprises: laminating the third and fourth electrodes in the stack so that the electrodes are affixed together in the stack; cutting a portion of the second overhang region around the perimeter of the third electrode with a laser; and removing the cut portion of the second overhang region from the third electrode so that the third electrode overhangs the fourth electrode by a second amount that is less than or approximately equal to the threshold amount. In some examples, the third electrode may be an anode and the fourth electrode may be a cathode.

In some aspects, the battery may be a solid-state battery and the stack may comprise a solid-state electrolyte separator between the first electrode and the second electrode. In some examples, the laser may cut the portion of the overhang region around the perimeter of the first electrode with a dimensional accuracy of less than 50% of a thickness of the solid-state electrolyte separator, e.g., so that the threshold amount is half of the thickness of the separator. In some aspects, the laser may be one or a combination of: a UV laser, a CO₂ laser, a Nd:YAG laser, and/or a Nd:YVO laser. However, other types of lasers and laser cutting methods are also contemplated.

In additional aspects, a method for cutting electrodes in a solid-state battery is provided that comprises: arranging electrodes in a stack, the stack comprising a first electrode and a second electrode, where the first electrode has a charge opposite a charge of the second electrode and wherein the first electrode has an overhang region that overhangs the second electrode around a perimeter of the second electrode; laminating the first and second electrodes in the stack so that the electrodes are affixed together in the stack; cutting a portion of the overhang region around the perimeter of the first electrode with a laser; removing the cut portion of the overhang region from the first electrode so that the first electrode overhangs the second electrode by an amount that is less than or approximately equal to a threshold amount; and sealing the stack inside a pouch. In some examples, threshold amount may be half thickness of separator. In some examples, the first electrode may be a negative electrode (e.g., an anode) and the second electrode may be a positive electrode (e.g., a cathode). In some aspects, the laser may comprise one of a UV laser, a CO₂ laser, a Nd:YAG laser, or a Nd:YVO laser.

In additional aspects, a method for cutting electrodes in a solid-state battery is provided that comprises: arranging electrodes in a stack, the stack comprising a first electrode, a second electrode, a third electrode, and a fourth electrode where each of the first electrode and third electrode have a charge opposite a charge of the second electrode and third electrode; wherein the first electrode has a first overhang region that overhangs the second electrode around a perimeter of the second electrode; wherein the third electrode has a second overhang region that overhangs the fourth electrode around a perimeter of the fourth electrode; laminating the first, second, third, and fourth electrodes in the stack so that the electrodes are affixed together in the stack; cutting a portion of the first overhang region around the perimeter of the first electrode with a laser; cutting a portion of the second overhang region around the perimeter of the third electrode with a laser; removing the cut portion of the first overhang region from the first electrode so that the first electrode overhangs the second electrode by a first amount that is less than or approximately equal to a threshold amount; removing the cut portion of the second overhang region from the third electrode so that the third electrode overhangs the fourth electrode by a second amount that is less than or approximately equal to the threshold amount; and sealing the stack inside a pouch. In some examples, the threshold amount may be approximately 1.0 mm. In some examples, the first and third electrodes may be anodes and the second and fourth electrodes may be cathodes.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for cutting electrodes in a battery, comprising:
arranging electrodes in a stack, the stack comprising a first electrode and a second electrode, where the first electrode has a charge opposite a charge of the second electrode and wherein the first electrode has an overhang region that overhangs the second electrode around a perimeter of the second electrode;
laminating the first and second electrodes in the stack so that the electrodes are affixed together in the stack;
cutting a portion of the overhang region around the perimeter of the first electrode with a laser; and
removing the cut portion of the overhang region from the first electrode so that the first electrode overhangs the second electrode by an amount that is less than or approximately equal to a threshold amount.

2. The method of claim 1, further comprising sealing the stack inside a pouch.

3. The method of claim 1, wherein the battery is a solid-state battery.

4. The method of claim 1, wherein the first electrode is separated from the second electrode by a separator and the threshold amount is half of a thickness of the separator.

5. The method of claim 4, wherein the separator is a solid-state electrolyte separator.

6. The method of claim 1, wherein the first electrode is an anode and the second electrode is a cathode.

7. The method of claim 1, wherein the stack comprises a third electrode and a fourth electrode, where the third electrode has a charge opposite a charge of the fourth electrode and wherein the third electrode has a second overhang region that overhangs the fourth electrode around a perimeter of the fourth electrode; and
wherein the method further comprises:
laminating the third and fourth electrodes in the stack so that the electrodes are affixed together in the stack;
cutting a portion of the second overhang region around the perimeter of the third electrode with a laser; and
removing the cut portion of the second overhang region from the third electrode so that the third electrode overhangs the fourth electrode by a second amount that is less than or approximately equal to the threshold amount.

8. The method of claim 7, wherein the third electrode is an anode and the fourth electrode is a cathode.

9. The method of claim 1, wherein the battery is a solid-state battery and the stack comprises a solid-state electrolyte separator between the first electrode and the second electrode.

10. The method of claim 9, where the laser cuts the portion of the overhang region around the perimeter of the first electrode with a dimensional accuracy of less than 50% of a thickness of the solid electrolyte separator.

11. The method of claim 1, where the laser is a UV laser.

12. The method of claim 1, where the laser is a CO₂ laser.

13. The method of claim 1, where the laser is a Nd:YAG laser.

14. The method of claim 1, where the laser is a Nd:YVO laser.

15. A method for cutting electrodes in a solid-state battery, comprising:
arranging electrodes in a stack, the stack comprising a first electrode and a second electrode, where the first electrode has a charge opposite a charge of the second electrode and wherein the first electrode has an overhang region that overhangs the second electrode around a perimeter of the second electrode;
laminating the first and second electrodes in the stack so that the electrodes are affixed together in the stack;
cutting a portion of the overhang region around the perimeter of the first electrode with a laser;
removing the cut portion of the overhang region from the first electrode so that the first electrode overhangs the second electrode by an amount that is less than or approximately equal to a threshold amount; and
sealing the stack inside a pouch.

16. The method of claim 15, wherein the first electrode is an anode and the second electrode is a cathode.

17. The method of claim 15, wherein the laser comprises one of a UV laser, a CO₂ laser, a Nd:YAG laser, or a Nd:YVO laser.

18. A method for cutting electrodes in a solid-state battery, comprising:
arranging electrodes in a stack, the stack comprising a first electrode, a second electrode, a third electrode, and a fourth electrode where each of the first electrode and third electrode have a charge opposite a charge of the second electrode and third electrode;
wherein the first electrode has a first overhang region that overhangs the second electrode around a perimeter of the second electrode;
wherein the third electrode has a second overhang region that overhangs the fourth electrode around a perimeter of the fourth electrode;
laminating the first, second, third, and fourth electrodes in the stack so that the electrodes are affixed together in the stack;
cutting a portion of the first overhang region around the perimeter of the first electrode with a laser;
cutting a portion of the second overhang region around the perimeter of the third electrode with a laser;
removing the cut portion of the first overhang region from the first electrode so that the first electrode overhangs the second electrode by a first amount that is less than or approximately equal to a threshold amount;
removing the cut portion of the second overhang region from the third electrode so that the third electrode overhangs the fourth electrode by a second amount that is less than or approximately equal to the threshold amount; and
sealing the stack inside a pouch.

19. The method of claim 18, wherein the threshold amount is half a thickness of a separator separating the first and second electrodes or separating the third and fourth electrodes.

20. The method of claim 18, wherein the first and third electrodes are anodes and the second and fourth electrodes are cathodes.
